(19) United States
(12) Patent Application Publication
(10) Pub. No.: US 2023/0385810 A1
(43) Pub. Date: Nov. 30, 2023

(54) CFILTER CACHEING FOR CRYPTO CURRENCY WALLET

(71) Applicant: MatterFi, Sheridan, WY (US)

(72) Inventor: Michal Pospieszalski, West Hollywood, CA (US)

(73) Assignee: MatterFi, Sheridan, WY (US)

(21) Appl. No.: 18/301,773

(22) Filed: Apr. 17, 2023

Related U.S. Application Data
(60) Provisional application No. 63/331,944, filed on Apr. 18, 2022.

(51) Int. Cl. G06Q 20/36

(52) U.S. Cl. CPC G06Q 20/3672

(57) ABSTRACT

A cryptocurrency wallet included preloaded data that consists of a copy of the addresses involved in blocks from a blockchain. The wallet updates the account balance to the most recent block by examining the preloaded copy of addresses involved in blocks, and then retrieving the addresses involved in blocks absent in the preloaded data. The preloaded data in the wallet may be compressed, and the compression may utilize Golomb-Rice encoding sets for compression. Additionally, the preloaded data may be stored in binary format.

### TECHNICAL FIELD

The present disclosure relates to cryptocurrency wallets and, more specifically, to determining the balance of a crypto currency wallet.

### BACKGROUND

Blockchain wallets need to calculate the balance by examining the transaction history on the blockchain. The transaction history on the blockchain can span many years and be very large in size, making it impractical for the crypto wallet to have a copy of all the transactions of the entire transaction history of the blockchain. Various approaches have been developed to minimize the amount of information needed to be downloaded and process to improve the performance of the wallet to give an accurate and up-to-date balance. Some of these approaches provide benefits in terms of improved performance but at the cost data leaks that weakens privacy of the wallet. In addition, having the wallet parse through all the transactions to determine the total available cryptocurrency assets under control of the private keys in the wallet can take a large amount of computation and time.

What is needed is a way to minimize the amount of information needed to download and quickly determine the assets under control of the private keys on the wallet.

### BRIEF DESCRIPTION OF THE DRAWINGS

FIG. 1 is an illustration of a block diagram of initialization of a crypto wallet with cfilter data.

FIG. 2 is an illustration of a block diagram the crypto wallet determining crypto balances.

FIG. 3 is an illustration of a flowchart for updating the wallet balance using cached cfilter data.

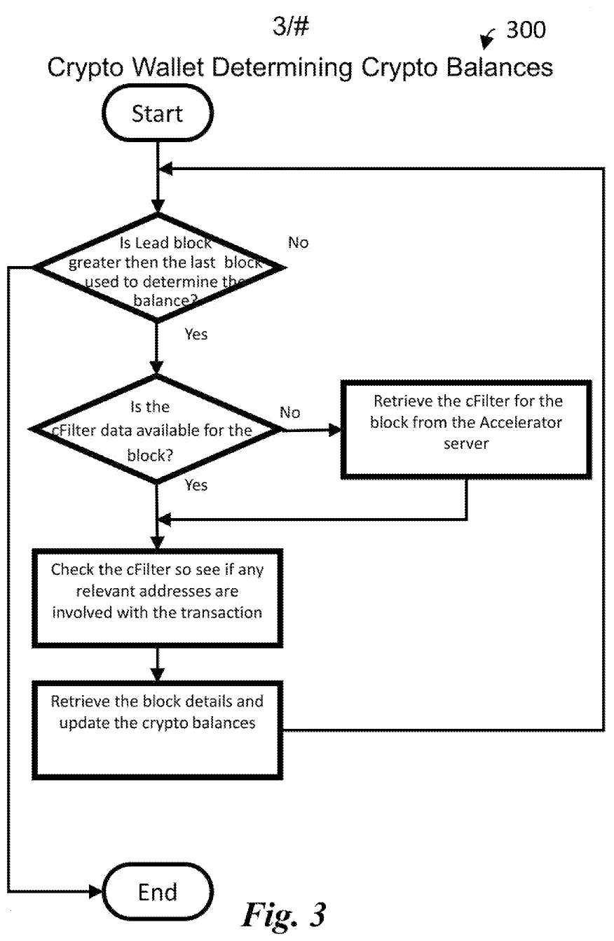

### DETAILED DESCRIPTION

One solution tried is the use of Bloom Filters, see url https://bitcoinops.org/en/topics/transaction-bloom-filtering/ for more details. But, bloom filters leak data since the filtering may allow an attacker to associate related blocks and gleam some information about related transactions and thus related blockchain addresses.

In contrast if the entire blockchain addresses involved in each block is compressed and sent to the wallet then that compressed block address information, also known as cfilters, are identical across all wallets, thus there is no privacy leak.

Using the cfilters approach instead of providing filtered information to the wallet, as is done with Bloom filtering, a compressed version of the block addresses to the wallet and then the wallet applies the filter against the compressed address information, i.e. the cfilter. The compression may be provided by using a compression algorithm like Golamb-Rice encoding sets.

The wallets receive the exact same cfilters from the accelerator server and then a wallet may compute their balances by determining which blocks have their unspent balances and then they contact the peer network for that particular chain to get the actual blocks and find their balances.

The accelerator server can be a single or multiple servers.

The cfilters compression may be an implement of Golomb-Rice Encoded Sets, and may be more specifically Rice's version. Rice coding (invented by Robert F. Rice) denotes using a subset of the family of Golomb codes to produce a simpler (but possibly suboptimal) prefix code. Rice used this set of codes in an adaptive coding scheme; “Rice coding” can refer either to that adaptive scheme or to using that subset of Golomb codes. Rice codes have a tunable parameter that is a power of two.

Rice codes, as opposed to Golomb, uses a subset (only powers of two) of the tunable parameters. Since geometric distributions often vary with time, are not precisely known, or both, selecting the seemingly optimal code—as is done with Golomb coding—might not be advantageous. For more details see https://en.wikipedia.org/wiki/Golomb_coding.

The advantage of the cfilter is that since the cfilters are generated from every block in a chain they can be preloaded into the wallet binary and therefore avoid a long initialization download on the first use of the wallet. The only downloads the wallet needs to do is to download any new blocks that the binary cfilters fail to have. Those cfilters missing from the binary may be requested from an accelerator server.

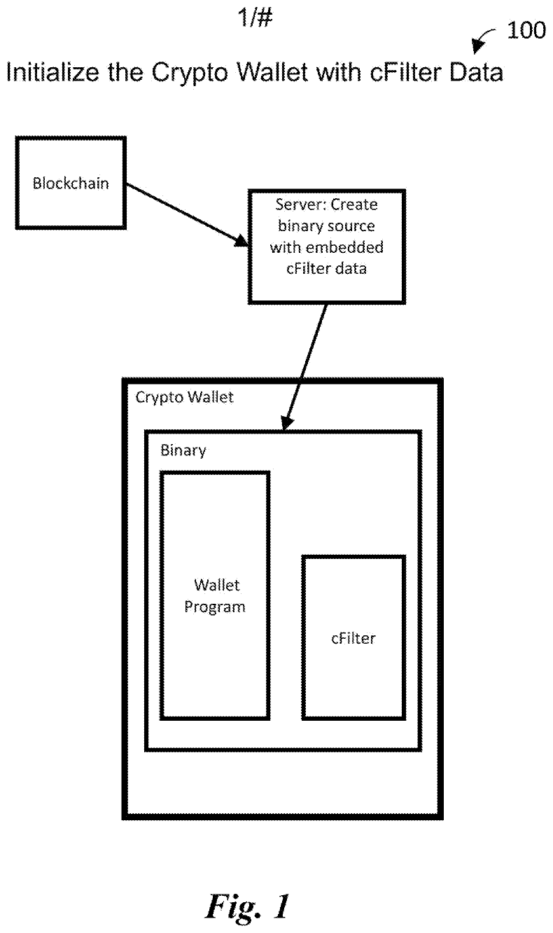

FIG. 1. The crypto wallet may download from a server (example an accelerator server) the block headers for all blockchains (for example, Bitcoin, Ethereum etc.), that the wallet is interested in from the accelerator server.

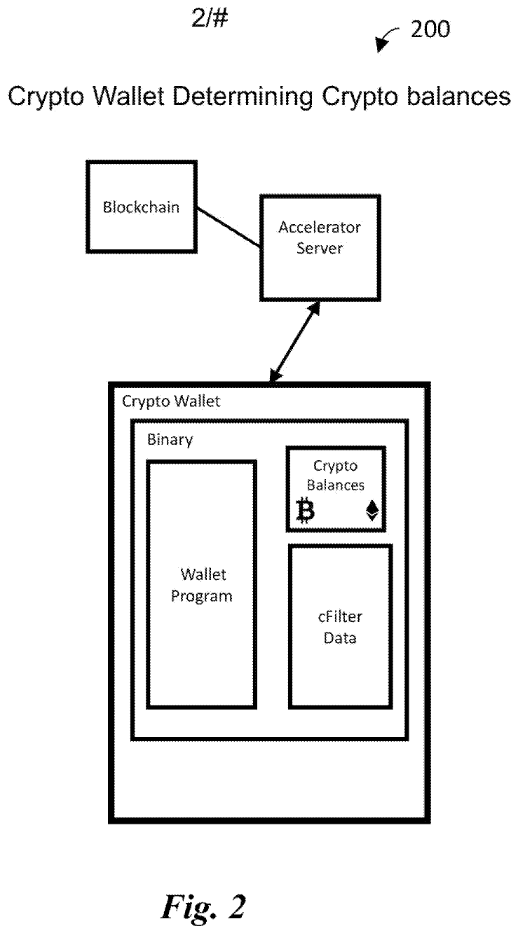

FIG. 2. The crypto wallet may obtain the corresponding cfilters for all the block headers. The program on the crypto wallet may get the cfilters from the local cache that came in the binary. When the wallet program fails to find the cfilter in the local cache for a particular block then the crypto wallet may get the cfilters for that block from the accelerator server.

By having the cfilter data for most blocks it enables time saving in synching by eliminating the need to download gigabytes of data, for example Bitcoin may have cfilters that total 30 GB in size. For Bitcoin the wallet may already have 29 GB of cfilters installed with the binary code and the crypto wallet may only needs to download the most recent 1-2 GB to have a full synchronization with the current blockchain as provided by the accelerator server.

Privacy is preserved because as the cfilter data is generic and the same for all wallets as it moves through all entities on the network thus as the information moving no information is leaked and privacy is preserved. Since all the data going to the wallet is the same no entity in the network except the wallet itself can determine the transactions that are impacting relevant addresses in order to determine crypto currency (i.e. balances) under control of the wallet.

Cfilter caching, also known as wallet bootstrapping, may allow a crypto wallet to quickly reach operational state on its initial startup by utilizing static block header and cfilter data that is directly embedded in the program running on the crypto wallet.

The wallet may set a peer that is actually pointing back to itself so the same code that retrieves from the accelerator server may be used, by setting a preferred peer that points back to the local cache. the code think it is going over the network but in actuality the code is checking local data

The wallet code implementation may be able to set a preferred accelerator server with a method like SetPreferredP2PPeer, and to retrieve the preferred accelerator server with a command like PreferedP2PPeer( ).

The Wallet may have an Client::Imp:: startup the preferred peer must be initialized with the rest of the servers, if it is set.

The wallet may have a Client::Imp::process_request function contains the logic for routing blockchain sync requests. The process_request function may use the get_provider to choose a random peer which is known to be active for the specified blockchain.

The Wallet may be programed that if the preferred peer is set, and if the preferred peer is active (present in providers_), and if the preferred peer's reported block height is above the value specified in the outgoing sync request message, then route the message to the preferred peer. Otherwise route it to a random peer.

The data which will make up the bootstrap files is currently generated by the accelerator server also known as the metier-server an interface, for example an RPC interface, may allow the wallet to instruct the metier-server to write bootstrap files.

The accelerator server may be able to respond to request from a wallet, the accelerator server may receive the request via a RPC (Remote Procedure Call), or other program communication over network like secure sockets, https or other types of synchronous or asyncrolnous program communication channels, or network communication channels.

The RPC protocol may have every request message receive one immediate response message, and depending on the request type may receive one or more delayed responses and/or push notifications.

For example executing a SendPayment request may require several preconditions. If the preconditions are met at the time of receiving the request then the immediate response may contain the final success or failure status. If on the other hand the preconditions are not met, then the immediate response will indicate that processing has been deferred while the accelerator server attempts to establish the preconditions. At some point in the future the payment will either be successfully sent or reach at permanent failure state and at this point the RPC server will send a deferred response containing the final resolution.

If a wallet sends a GetAccountActivity or GetAccountBalance request, then the wallet may receive an immediate response with the requested data, however in addition to this otagent will remember that the requestor is interested in the specified account and will send push notifications to the original requestor any time an update for this account is available.

The accelerator server may have a function for example WriteBootstrapFile(string location). The return type should contain enough information to communicate success, or any of the specific error conditions. For example, the program may define an enum class and use that as the return a value. The return may respond with a standard error_code is also acceptable

The WriteBootstrapFile( . . . ) function may decide on a target block height. the target block height may be a multiple of a size, for example a multiple of 1000. The target block height may be at least 1000 below the newest block on the block chain. The wallet may determine the newest block by accessing it from a sync database as reported by a function, for example blockchain::database::common::Sync::Tip( ).

For example, if the tip height is 1001999 then the stop height may be 1000000. If the tip height is 10002000 then the stop height may be 1001000

The bootstrap file may be a sparse file and memory map it.

The file name may be tickersymbol_bootstrap_1-stopheight.bin.

The initial size of the bootstrap file may be specified as 1 TiB.

Once the file is memory mapped the program can write to it using std::memcpy.

All integers written to the cfilter bootstrap file may be in little endian order. Before copying any integer to the bootstrap file the program may first construct a boost::endian::little_uint64_buf_t or boost::endian::little_int64_buf_t and then memcpy from that object. This ensures that bootstrap files are valid even if they are created by on a computer running on a big endian architecture.

To read integers from the bootstrap file, first memcpy them into the appropriate boost::endian buffer and then call the value( ) function.

The program may write the bootstrap data packets for each block starting from 0 and stopping at the target block height. As the program writes the data packets, the program may fill in the appropriate index data. Once the program writes all the data packets, the program may truncate the file to the correct size. WriteBootstrapFile may not be a blocking call. WriteBootstrapFile should first ensure the preconditions for operation are met, and if they are it may spawn a background task to write the data and return true. The parent object may not destruct until the background job has exited.

The RPC command: WriteBootstrapFile may take one string argument representing the directory in which the file will be written, and an argument indicating blockchain whose bootstrap file should be created.

The RPC command may provide an immediate response of success may indicate the process was successfully initiated, or else the response may be one of the following errors: 1) the specified blockchain is invalid or not active, 2) the specified directory exists but is not writable, 3) the specified directory is a file instead of a directory, or 4) not enough data exists to create a bootstrap file.

A coding library may contain the bootstrap data, as well as the tool for generating it

A code build project may be setup with two targets. One target is the executable for the generator tool. The other target is an object library that implements the functions declared in src/Bootstrap.hpp.

This repository is intended to be included as a submodule in the accelerator server and the object library created by the code build project may be added to the accelerator server executable using target_sources( ) and TARGET_OBJECTS

The code build project may be being compiled standalone, to produce the build tool, or the code build project may be being bundled, so produce the object library and not the generator tool.

The generator may accept two arguments, 1) the output file path, and 2) a list of bootstrap files to embed. After parsing and indexing the supplied bootstrap files, the generator should create a Bootstrap.cpp file which implements the functions declared in Bootstrap.hpp. Each bootstrap files may be embedded into one variable pesupplblockchain.

For example, in C:
static const auto btc_data_=std::array<unsigned char, Y>{ . . . }

Where “ . . . ” is a list of integer representations of the associated bytes.

There may be a get_bootstrap_data( ) function that will need to reinterpret_cast the array pointer from const unsigned char* to const std::byte*. Alternately the generator may create a user-defined literal which creates std::byte values from integers and uses std::array<std::byte, N> and thus skips the reinterpret_cast.

A get_bootstrap_height( ) function may return the value specified in the header of the associated variable, if it exists, or a 0 otherwise. A get_bootstrap_data( ) function may first check for a valid height argument by calling get_bootstrap_height( ) and may abort if the supply argument is out of range.

The function may only be called in one place.

The Bootstrap.cpp file created by the generator tool may be saved to the src/directory.

The wallet may listen on an arbitrary inproc endpoint and responds to a networkk query request with the static data contained in the bootstrap library.

There may be a function MessageType::query and MessageType::sync_request requests receive an immediate sync_ack message which informs the requestor of the node's best position for each supported blockchain. If the incoming message was a sync_request then following the sync_ack message a sync_reply message may be sent containing up to 4 mebibyte (MiB) of data starting from the block after the highest block reported by the requestor.

The inproc endpoint on which the wllet is listening as the PreferredP2PPeer and should be instantiated as after initialization.

An example of Bootstrap file format structure
Header section (32 bytes total)
1. version number (8 bytes, unsigned, little endian): 1
2. blockchain type (8 bytes, unsigned, little endian): value of opentxs::blockchain::Type enum
3. total number of blocks in file (8 bytes, unsigned, little endian)
4. reserved (8 bytes)
Index data section (16 bytes*the total number of blocks in the file)
One entry for each block in the file, in ascending block height order:
1. start position as a byte offset (8 bytes, unsigned, little endian)
2. size of the data packet (8 bytes, unsigned, little endian)
Data packet section (variable size)
The contents of the bootstrap data for each block, in the same order as the associated index.

An example of bootstrap file contains data for PKT block 0 only, and if the size of the block 0 data is 320 bytes, then the bootstrap file will be 32+16+320=368 bytes.
Bytes 0-7 will contain the little endian representation of 1
Bytes 8-15 will contain the little endian representation of 9
Bytes 16-23 will contain the little endian representation of 1
Bytes 24-31 have no specified value
Bytes 32-39 will contain the little endian representation of 48
Bytes 40-47 will contain the little endian representation of 320
Bytes 48-367 will contain the data for block 0

If the bootstrap instead contained data for two blocks (block 0 and block 1), then one additional index item would be needed and the data for block 0 would begin at offset 64 instead of offset 48.

Numerous specific details are set forth in order to aid in developing a thorough understanding, however, it will be understood that in practice, the functionality or capability may be practiced without the specific details presented. In other instances, well-known methods, procedures, components, units, and circuits are not described in detail so as not to obscure the discussion.

The subject matter described above is provided by way of illustration only and should not be construed as limiting. Various modifications and changes can be made to the subject matter described without following the example embodiments and applications illustrated and described and without departing from the spirit and scope of the present invention, which was set forth above.

What is claimed is:

1. A crypto wallet comprising:
a preload data, where the preloaded data is a copy of the addresses involved in blocks from a blockchain,
updating the crypto account balance to the latest block by first checking the preloaded copy of the addresses involved in blocks, and second retrieving the addresses for any blocks not in the preloaded copy.

2. The crypto wallet of claim 1 where the preloaded data is compressed.

3. The crypto wallet of claim 2 where the preloaded data is compressed using golamb-rice encoding sets.

4. The crypto wallet of claim 1 where the preload data is in the binary.
